(19) United States
(12) Patent Application Publication
(10) Pub. No.: US 2020/0233225 A1
(43) Pub. Date: Jul. 23, 2020

(54) LIGHT BEAM COLLIMATION STRUCTURE, SUBSTRATE, BACKLIGHT MODULE, AND DISPLAY APPARATUS

(71) Applicant: BOE TECHNOLOGY GROUP CO., LTD., Beijing (CN)

(72) Inventors: Jifeng TAN, Beijing (CN); Pengxia LIANG, Beijing (CN)

(21) Appl. No.: 16/076,874

(22) PCT Filed: Jan. 17, 2018
(86) PCT No.: PCT/CN2018/073045

§ 371 Date: Aug. 9, 2018

(30) Foreign Application Priority Data
Jun. 5, 2017 (CN) 201710413696.4

(51) Int. Cl. G02B 27/30; G02F 1/01; G02B 19/00

(52) U.S. Cl. CPC G02B 27/30; G02B 19/0028; G02F 1/0105

(57) ABSTRACT

The present disclosure provides a light beam collimation structure, a substrate, a backlight module, and a display apparatus. The light beam collimation structure comprises: a lens (21) having a first primary axis (212) and a first focus (211), the lens is used for transmitting and collimating light from the first focus into parallel light in parallel with the first primary axis; a grating structure (22) disposed outside of a region formed by the first focus and a clear aperture of the lens and in a direction of the first primary axis, located between the lens and the first focus, the grating structure including a transmissive grating (221) for transmitting and collimating light from the first focus into parallel light in parallel with the first primary axis.

### CROSS-REFERENCE TO RELATED APPLICATIONS

This application is a U.S. National Stage under 35 U.S.C. § 371 of International Application No. PCT/CN2018/073045 as filed on Jan. 17, 2018, which claims the priority to the Chinese patent application No. 201710413696.4, filed on Jun. 5, 2017. The disclosures of each of these applications are hereby incorporated herein by reference in their entirety into this application.

### TECHNICAL FIELD

The present disclosure relates to a light beam collimation structure, a substrate, a backlight module, and a display apparatus.

### BACKGROUND

In recent years, with the rapid development of various display devices, their power consumptions have attracted more attention.

### SUMMARY

At least one embodiment of the present disclosure provides a light beam collimation structure, comprising:

a lens having a first primary axis and a first focus, for transmitting and collimating light from the first focus into parallel light in parallel with the first primary axis;

a grating structure disposed outside of a region formed by the first focus and a clear aperture of the lens, and in a direction of the first primary axis, located between the lens and the first focus, the grating structure including a transmissive grating for transmitting and collimating light from the first focus into parallel light in parallel with the first primary axis.

In one alternative embodiment of the present disclosure, in a direction perpendicular to the first primary axis, the transmissive grating is located in a region outside of the clear aperture of the lens.

In one alternative embodiment of the present disclosure, the transmissive grating is a step grating.

In one alternative embodiment of the present disclosure, the transmissive grating has a step number of greater than 3.

In one alternative embodiment of the present disclosure, the transmissive grating has a period ranging from 0.5 to 5 μm and a refractive index ranging from 1.2 to 2.

In one alternative embodiment of the present disclosure, the grating structure further includes a reflective grating for reflecting light from the first focus, the reflective grating is disposed outside of a region formed by the first focus and both ends of the transmissive grating and located outside of a light exit region of transmitted light of the transmissive grating.

In one alternative embodiment of the present disclosure, the reflective grating includes a first reflective grating and a second reflective grating, the first reflective grating is located on one side of the first focus, and the second reflective grating is located on the other side of the first focus.

One embodiment of the present disclosure provides a light beam collimation substrate including a plurality of the aforementioned light beam collimation structures. A distance between lenses of the respective light beam collimation structures is greater than zero, and the first primary axes of the lenses of the respective light beam collimation structures are in parallel. In a direction perpendicular to the first primary axis, the transmissive grating is located between two adjacent lenses.

In one alternative embodiment of the present disclosure, a width of the transmissive grating is equal to the distance between the two adjacent lenses of the transmissive grating.

In one alternative embodiment of the present disclosure, when the light beam collimation structure comprises the reflective grating, in a direction perpendicular to the first primary axis, the reflective grating is located between two adjacent transmissive gratings, the two adjacent transmissive gratings being two transmissive gratings closest to both sides of the lens of the light beam collimation structure where the reflective grating resides, or, the reflective grating is located between a boundary of the light beam collimation substrate and the transmissive grating which belongs to the same light beam collimation structure as the reflective grating.

In one alternative embodiment of the present disclosure, the light beam collimation substrate further comprises a second lens having a second primary axis and a second focus, the second lens for transmitting and collimating light form the second focus into parallel light in parallel with the second primary axis. The second primary axis is parallel to the first primary axis. One side of the second lens is adjacent to one light beam collimation structure, and the other side is close to the boundary of the light beam collimation substrate. A distance between the second lens and the adjacent lens is greater than zero.

In one alternative embodiment of the present disclosure, the light beam collimation substrate further comprises a third reflective grating and a fourth reflective grating, which are disposed below the second lens and outside of a region formed by the second focus and a clear aperture of the second lens, located between the second lens and the second focus in a direction of the second primary axis, and located between a transmissive grating adjacent to the third reflective grating and the fourth reflective grating and a boundary of the light beam collimation substrate in a direction perpendicular to the second primary axis.

One embodiment of the present disclosure provides a backlight module, comprising: a light source substrate, and the aforementioned light beam collimation substrate disposed on a light exit side of the light source substrate, the light source substrate including a plurality of light sources, the plurality of light sources being in one-to-one correspondence with lenses on the light beam collimation substrate and disposed on focuses of corresponding lenses.

One embodiment of the present disclosure provides a display apparatus, comprising the aforementioned backlight module.

Features and advantages of the present disclosure will be set forth in the specification which follows, and partially become obvious from the specification or are understood by implementing the present disclosure. The objects and advantages of the present disclosure can be realized and obtained by the structure as particularly indicated in the specification, claims and drawings.

### BRIEF DESCRIPTION OF THE DRAWINGS

The drawings are used to provide a further understanding of the technical solutions of the present disclosure, constitute a part of the specification, are used to explain the technical solutions of the present disclosure together with the embodiments of the present application, and do not constitute a limitation of the technical solutions of the present disclosure.

FIG. 1 is a schematic diagram of the light beam collimation structure in related technologies;

FIG. 2 is a schematic diagram of the light beam collimation structure as provided in one embodiment of the present disclosure;

FIG. 3 is a schematic diagram of the light beam collimation substrate as provided in one embodiment of the present disclosure;

FIG. 4 is a schematic diagram of the light beam collimation substrate as provided in one embodiment of the present disclosure;

FIG. 5 is a schematic diagram of the light beam collimation substrate as provided in one embodiment of the present disclosure;

FIG. 6 is a schematic diagram of the light beam collimation substrate as provided in one embodiment of the present disclosure;

FIG. 7 is a schematic diagram of the backlight module as provided in one embodiment of the present disclosure;

FIG. 8 is a schematic diagram of the backlight module as provided in one embodiment of the present disclosure;

FIG. 9 is a schematic diagram of light exit of the transmissive grating of one embodiment of the present disclosure;

FIG. 10 is a schematic diagram of simulation results of the collimation effect as provided in one embodiment of the present disclosure;

FIG. 11 is a schematic diagram of simulation results of the light exit efficiency as provided in one embodiment of the present disclosure.

### DETAILED DESCRIPTION

To make the objectives, technical solutions and advantages of the present disclosure more clear, the embodiments of the present disclosure will be described in detail below with reference to the accompanying drawings. It should be noted that, in the case of no conflict, the features in the embodiments and the embodiments in the present application may be arbitrarily combined with each other.

The steps illustrated in the flowchart of the figures may be executed in a computer system such as a set of computer executable instructions. Also, although logical sequences are shown in the flowcharts, in some cases the steps shown or described may be performed in a different order than the ones described herein.

Unless otherwise defined, technical terms or scientific terms used in the present disclosure are intended to be understood in the ordinary meaning of those of ordinary skill in the art. The words “first”, “second”, and similar terms used in the present disclosure do not denote any order, quantity, or importance, but are used to distinguish different components. The words “including” or “comprising”, and the like, are intended to mean that the elements or items that precede the word covers the elements or items or its equivalences that follow the word, without excluding other elements or items. “Connected” or “connecting” and the like are not limited to physical or mechanical connections, but may include electrical connections, whether direct or indirect. “Upper”, “lower”, “left”, “right”, etc. are only used to indicate the relative positional relationship, and when the absolute position of the object to be described is changed, the relative positional relationship may also change accordingly.

Since the backlight module in a display panel in related technologies emit light beams at a large divergent angle, a human eye can only receive little light energy, which largely reduces the utilization rate of light energy so as to increase a power consumption of the display panel. A backlight module capable of collimating light beams is used for reducing a divergent angle of exit light beams of the display panel such that exit light can be efficiently received by a human eye.

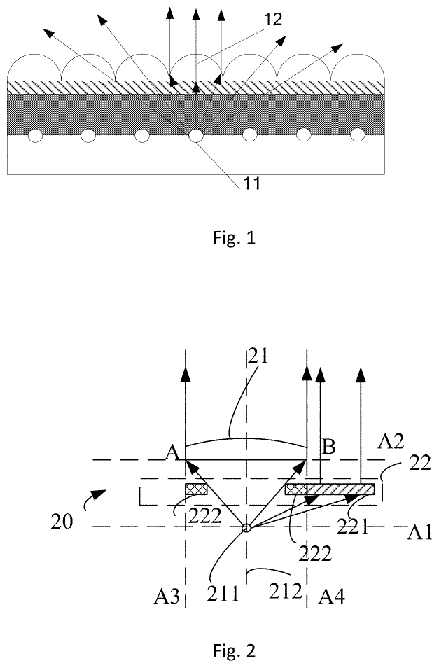

FIG. 1 illustrates a related technology of light beam collimation in which a lens is used to achieve backlight collimation. The light beam collimation structure comprises a lens 12 having a focus and a primary axis. A light-emitting point 11 is disposed on the focus of the lens 12. A plurality of light-emitting points 11 form an Organic Light-Emitting Diode (briefly referred to as OLED) lattice light source, and a plurality of lenses 12 form a collimation microlens array. An angle formed by a clear aperture of the lens 12 (namely a diameter of the lens 12 in a direction perpendicular to the primary axis) and the light-emitting point is referred to as an aperture angle of the lens, which describes a size of a light-receiving cone angle of the lens. A light beam emitted from the light-emitting point 11 within the aperture angle of the lens is collimated into parallel light in parallel with the primary axis of the lens 12 after being transmitted by the lens 12, and a light beam outside the aperture angle of the lens will be incident into an adjacent lens, which greatly affects an overall collimation effect. Therefore, the light beam collimation structure serves a collimation function for only light beams within the aperture angle of the lens, and light beams outside the aperture angle of the lens cannot be collimated. Thus, the utilization rate of light energy during collimation is low, which increases power consumptions of related devices comprising such light beam collimation structure.

One embodiment of the present disclosure provides a light beam collimation structure 20, as shown in FIG. 2, comprising:

a lens 21 having a first focus 211 and a first primary axis 212, the lens 21 is used for transmitting and collimating light from the first focus 211 into parallel light in parallel with the first primary axis 212;

a grating structure 22 disposed outside of a region formed by the first focus 211 and a clear aperture of the lens (specifically, a line connecting A and B in FIG. 2) and in a direction of the first primary axis 212, located between the lens and the first focus 211 (that is, located in a region between dashed line A1 and dashed line A2), the grating structure 22 including a transmissive grating 221 for transmitting and collimating light from the first focus 211 into parallel light in parallel with the first primary axis 212.

For example, the lens 21 may be a cylindrical lens, a spherical lens, or a liquid crystal lens. For example, a spherical lens may be selected.

For example, in a direction perpendicular to the first primary axis (namely a direction indicated by dashed line A1 or dashed line A2), the transmissive grating is located in a region outside of a clear aperture of the lens (that is, located in a region other than the region between dashed line A3 and dashed line A4, and specifically, a region on the left of dashed line A3 and a region on the right of dashed line A4). In addition, since the grating structure 22 is located outside of the region formed by the first focus 211 and the clear aperture of the lens, and in a direction of the first primary axis, located between the lens and the first focus, the transmissive grating 221 belonging to a part of the grating structure 22 is also located in a region other than the region between dashed line A3 and dashed line A4.

It should be noted that, the transmissive grating 221 may be located on the left of the lens 21 or located on the right of the lens 21.

For example, the transmissive grating is a step grating.

For example, the transmissive grating has a step number of greater than 3.

For example, the transmissive grating has a period ranging from 0.5 to 5 micrometers (μm) and a refractive index ranging from 1.2 to 2. Certainly, the aforementioned parameters are only examples, and other parameters may be selected as required.

In other embodiments, the grating structure 22 further includes a reflective grating 222, which is disposed outside of a region formed by the first focus and both ends of the transmissive grating and located outside of a light exit region of transmitted light of the transmissive grating. The reflective grating is used for reflecting light form the first focus. In addition, since the grating structure 22 is located outside of the region formed by the first focus 211 and the clear aperture of the lens, and in a direction of the first primary axis, located between the lens and the first focus, the transmissive grating belonging to a part of the grating structure 22 is also required to satisfy such requirement. The light beam will exit from a height gap between the transmissive grating and the lens and result in stray light. A function of the reflective grating is to reflect these light beams for reutilization. For example, these light beams may enter other lens or transmissive grating after multiple reflections and exit again, thus increasing a light exit efficiency.

For example, the reflective grating may include one or more reflective gratings, e.g. only the reflective grating located on the left of the first focus, or only the reflective grating located on the right of the first focus, or both the reflective grating located on the left of the first focus and the reflective grating located on the right of the first focus. That is, the grating structure includes a first reflective grating and a second reflective grating, the first reflective grating located on one side of the first focus, the second reflective grating located on the other side of the first focus.

It should be noted that, the transmissive grating and the reflective grating may be on the same layer, or on different layers as shown in FIG. 2. For example, the reflective grating may be moved upward or downward.

In the present embodiment, a grating structure is disposed outside of a divergent region formed by the clear aperture of the lens and the focus of the lens, and a function of the grating structure is to collimate a light beam incident at a large angle and outside the aperture angle of the lens. Further, the grating structure uses a step grating which is insensitive to the light beam incident at a large angle. Therefore, such a technical effect is obtained that a light beam within an aperture of the lens from the light source is transmitted by the lens in a collimated manner, and a light beam outside the aperture of the lens is transmitted in a collimated manner under the functions of diffraction of the grating and interference between the gratings, such that a light exit efficiency is largely increased while the technical effect of increasing collimation of the display device is achieved.

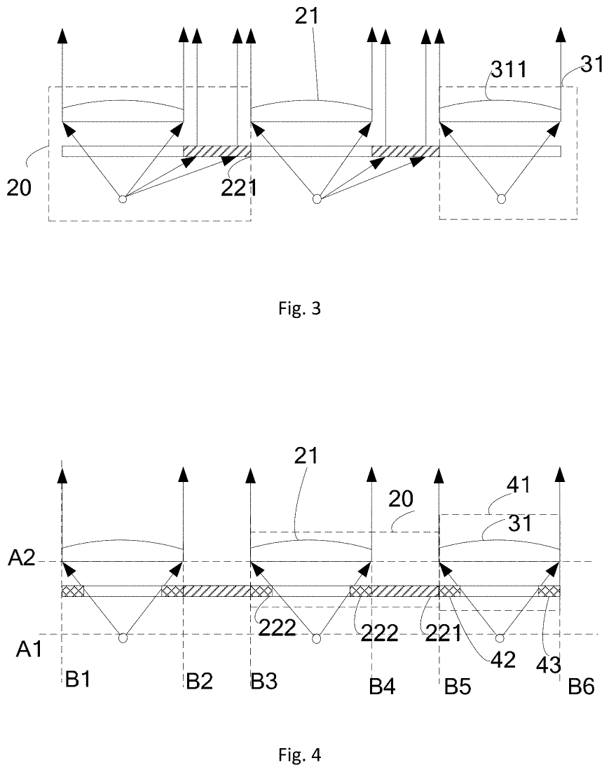

Another embodiment of the present disclosure provides a light beam collimation substrate including a plurality of the aforementioned light beam collimation structures 20, as shown in FIG. 3. A distance between lenses of the respective light beam collimation structures is greater than zero, and the first primary axes of the lenses of the respective light beam collimation structures are in parallel. In a direction perpendicular to the first primary axis, the transmissive grating 221 is located between two adjacent lenses. In the present embodiment, the light beam collimation structure includes only the transmissive grating and does not comprise the reflective grating, and the transmissive grating is located on the right of the lens. Alternatively, a width of the transmissive grating is equal to a distance between two lenses adjacent thereto. Certainly, a width of the transmissive grating may be less than a distance between two lenses adjacent thereto.

In addition, the light beam collimation substrate further comprises one light beam collimation structure 31 which includes only the lens and does not include the transmissive grating. Specifically, the light beam collimation substrate further comprises a second lens 311 having a second primary axis and a second focus. The second lens is used for transmitting and collimating the light from the second focus into parallel light in parallel with the second primary axis. The second primary axis is parallel to the first primary axis. One side of the second lens is adjacent to one light beam collimation structure, and the other side is close to a boundary of the light beam collimation substrate. A distance between the second lens and the adjacent lens is greater than zero. Typically, only one transmissive grating is required between two adjacent lenses. Therefore, there will be a light beam collimation structure that includes only the lens and does not include the transmissive grating.

It should be noted that, if the transmissive grating is located on the left of the lens, the leftmost light beam collimation structure of the light beam collimation substrate includes only the lens and does not include the transmissive lens.

In the present embodiment, a grating structure is disposed outside of a divergent region formed by the clear aperture of the lens and the focus thereof, and a function of the grating structure is to collimate a light beam incident at a large angle and outside the aperture angle of the lens. Further, the grating structure uses a step grating which is insensitive to the light beam incident at a large angle. Therefore, such a technical effect is obtained that a light beam within an aperture of the lens from the light source is transmitted by the lens in a collimated manner, and a light beam outside the aperture of the lens is transmitted in a collimated manner under the functions of diffraction of the grating and interference between the gratings, such that a light exit efficiency is largely increased while the technical effect of increasing collimation of the display device is achieved.

Another embodiment of the present disclosure provides a light beam collimation substrate. It differs from the above embodiment in that, the light beam collimation structure in the present embodiment further comprises a reflective grating.

As shown in FIG. 4, the light beam collimation substrate as provided in the present embodiment comprises a plurality of light beam collimation structures 20. A distance between lenses of the respective light beam collimation structures is greater than zero, and the first primary axes of the lenses of the respective light beam collimation structures are in parallel. In a direction perpendicular to the first primary axis, the transmissive grating 221 is located between two adjacent lenses. In the present embodiment, the transmissive grating is located on the right of the lens. Alternatively, a width of the transmissive grating is equal to a distance between two lenses adjacent thereto. Certainly, a width of the transmissive grating may also be less than a distance between two lenses adjacent thereto.

Generally, to facilitate the implementation, the lenses are on the same layer, the transmissive gratings are on the same layer, the reflective gratings are on the same layer, and the transmissive grating and the reflective grating may be on the same layer or on different layers.

The light beam collimation structure 20 further includes a reflective grating 222.

When the light beam collimation structure is adjacent to a boundary of the light beam collimation substrate, in a direction perpendicular to the first primary axis, the reflective grating 222 in the light beam collimation structure 20 is located between a boundary of the light beam collimation substrate and the transmissive grating which belongs to the same light beam collimation structure as the reflective grating, and specifically, located in a region between dashed line B1 and dashed line B2. In addition, since the grating structure 22 is required to be located between the first focus of the lens and the lens (namely a region between dashed line A1 and dashed line A2) and outside of a region formed by the first focus of the lens and the clear aperture of the lens, a region in which the reflective grating can be located may be a region formed by A1, A2, B1, and B2, except for the region formed by the first focus of the lens and the clear aperture of the lens.

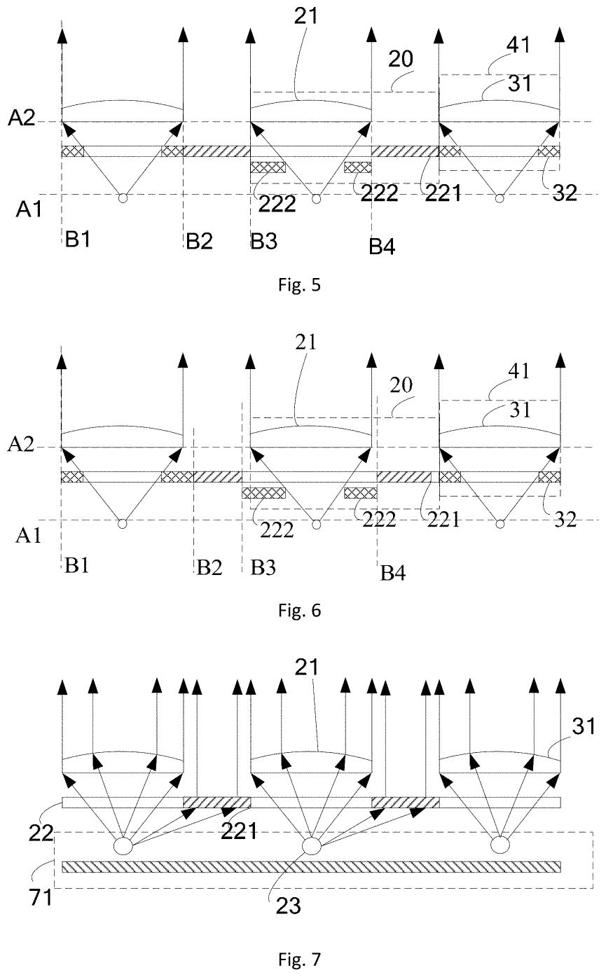

When the light beam collimation structure is not adjacent to a boundary of the light beam collimation substrate, that is, when the light beam collimation structure is a light collimation structure in the middle, in a direction perpendicular to the first primary axis, the reflective grating is located between two adjacent transmissive gratings, which are two transmissive gratings closest to both ends of the lens of the light beam collimation structure where the reflective grating resides, specifically located in a region between dashed line B3 and dashed line B4. In addition, since the grating structure 22 is required to be located between the first focus of the lens and the lens (namely a region between dashed line A1 and dashed line A2) and outside of a region formed by the first focus of the lens and the clear aperture of the lens, the allowable region of the reflective grating 222 may be a region formed by A1, A2, B1, and B2, except for a region formed by the first focus of the lens and the clear aperture of the lens. The reflective grating may be moved upward and downward in the allowable region thereof, and a width of the reflective grating is variable without exceeding a range of the allowable region thereof. As shown in FIG. 5, the location of the reflective grating 222 may be moved downward, where a width of the reflective grating may be increased. Alternatively, a width of the reflective grating is set as a maximum width at the current location. Certainly, the location of the reflective grating 222 may also be moved upward, where a width of the reflective grating may be reduced.

In addition, as shown in FIG. 4, the light beam collimation substrate further includes light beam collimation structure 41. Specifically, the light beam collimation structure 41 comprises a second lens 311 having a second primary axis and a second focus, and the second lens is used for transmitting and collimating light form the second focus into parallel light in parallel with the second primary axis. The second primary axis is parallel to the first primary axis. One side of the second lens is adjacent to one light beam collimation structure, and the other side is close to the boundary of the light beam collimation substrate. A distance between the second lens and the adjacent lens is greater than zero. The light beam collimation structure 41 further comprises a third reflective grating 42 and a fourth reflective grating 43, which are disposed below the second lens and outside of a region formed by the second focus and a clear aperture of the second lens, located between the second lens and the second focus in a direction of the second primary axis (between dashed line A1 and dashed line A2 since the second focus and the first focus are on the same layer), and in a direction perpendicular to the second primary axis, located between a transmissive grating adjacent to the third reflective grating and the fourth reflective grating and a boundary of the light beam collimation substrate (specifically, between dashed line B5 and dashed line B6).

It should be noted that, a width of the transmissive grating may be less than a distance between the lenses, where, as the location of the transmissive grating varies, locations of dashed lines B2, B3, and B4 vary, as shown in FIG. 6. The allowable region of the reflective grating varies accordingly.

In the present embodiment, a grating structure is disposed outside of a divergent region formed by the clear aperture of the lens and the focus thereof, and a function of the grating structure is to collimate a light beam incident at a large angle and outside the aperture angle of the lens. Further, the grating structure uses a step grating which is insensitive to the light beam incident at a large angle. Therefore, such a technical effect is obtained that a light beam within an aperture of the lens from the light source is transmitted by the lens in a collimated manner, and a light beam outside the aperture of the lens is transmitted in a collimated manner under the functions of diffraction of the grating and interference between the gratings, such that a light exit efficiency is largely increased while the technical effect of increasing collimation of the display device is achieved.

In addition, the reflective grating may reflect the light beams exiting from a height gap between the transmissive grating and the lens for reutilization. For example, these light beams may enter other lens or transmissive grating after multiple reflections and exit again, thus increasing a light exit efficiency.

Another embodiment of the present disclosure provides a backlight module, as shown in FIG. 7, comprising: a light source substrate 71 having a plurality of light sources 23, and a light beam collimation substrate disposed on a light exit side of the light sources 23. The plurality of light sources are in one-to-one correspondence with lenses on the light beam collimation substrate and disposed on focuses of the corresponding lenses. In the present embodiment, the light beam collimation substrate includes only the transmissive grating and does not include the reflective grating.

For example, a reflective electrode may be disposed at a location close to the light sources 23 in the light source substrate 71.

For example, the light source 23 is a dot-like light source, and can be a Light Emitting Diode (briefly referred to as LED), including an inorganic LED, an OLED, a Micro-LED, and a quantum-dot LED.

In the present embodiment, a grating structure is disposed outside of a divergent region formed by the clear aperture of the lens and the focus thereof, and a function of the grating structure is to collimate a light beam incident at a large angle and outside the aperture angle of the lens. Further, the grating structure uses a step grating which is insensitive to the light beam incident at a large angle. Therefore, such a technical effect is obtained that a light beam within an aperture of the lens from the light source is transmitted by the lens in a collimated manner, and a light beam outside the aperture of the lens is transmitted in a collimated manner under the functions of diffraction of the grating and interference between the gratings, such that a light exit efficiency is largely increased while the technical effect of increasing collimation of the display device is achieved.

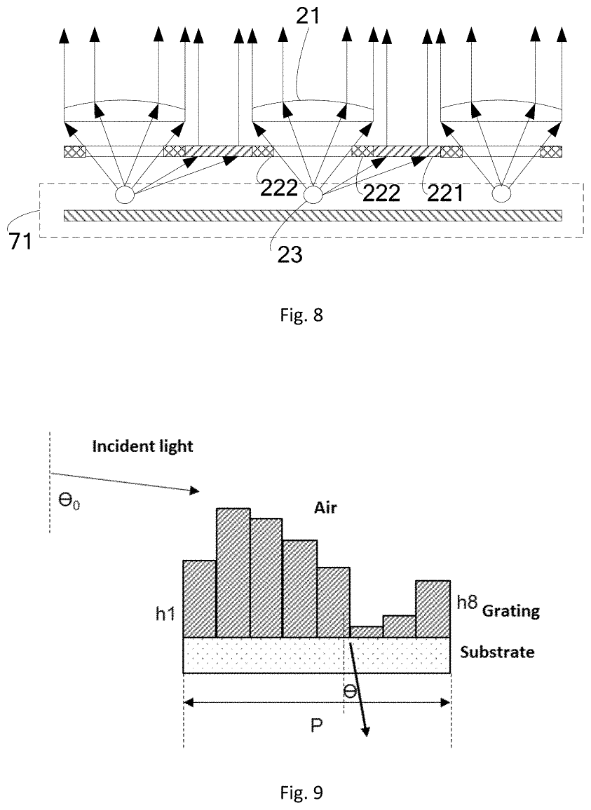

FIG. 8 is a schematic diagram of another backlight module. The backlight module differs from that in FIG. 7 in that, the light beam collimation substrate included in the backlight module as shown in FIG. 8 includes a reflective grating.

The reflective grating may reflect the light beams exiting from a height gap between the transmissive grating and the lens for reutilization. For example, these light beams may enter other lens or transmissive grating after multiple reflections and exit again, thus increasing a light exit efficiency.

Another embodiment of the present disclosure provides a display apparatus, comprising the aforementioned backlight module. The display apparatus may be a liquid crystal panel, a liquid crystal display, a liquid crystal TV, an OLED panel, an OLED display, an OLED TV, an electronic paper, or other display apparatus. The implementation of the display apparatus may refer to the aforementioned embodiment.

Another embodiment of the present disclosure uses a simulation experiment to explain an effect on the collimation effect by parameters of the transmissive grating.

FIG. 9 is a schematic diagram in which a light beam passes through the transmissive grating, where, θ₀ is an incident angle of incident light, and θ is an exit angle of exit light, and h1 to h8 are step numbers of the transmissive grating. Parameters are shown in table 1 and table 2.

TABLE 1

| | Refractive index | | Period of | Step number of | Refractive | | | | |
|---|---|---|---|---|---|---|---|---|---|
| Incident | of transmissive | Refractive | transmissive | transmissive | index of | | | Exit | Ratio of θ |
| angle θ₀ | grating | index of base | grating | grating | incident medium | Transmittance | Reflectance | angle | to exit light |
| 85° | 1.8 | 1.5 | 1.8 um | 8 | 1.0 | 58% | 42% | 0.14° | 90% |

TABLE 2
Height of Step of Transmissive Grating

| Step | Height (μm) |
|---|---|
| h1 | 1.21 |
| h2 | 1.94 |
| h3 | 1.71 |
| h4 | 1.45 |
| h5 | 1.18 |
| h6 | 1.19 |
| h7 | 0.32 |
| h8 | 0.99 |

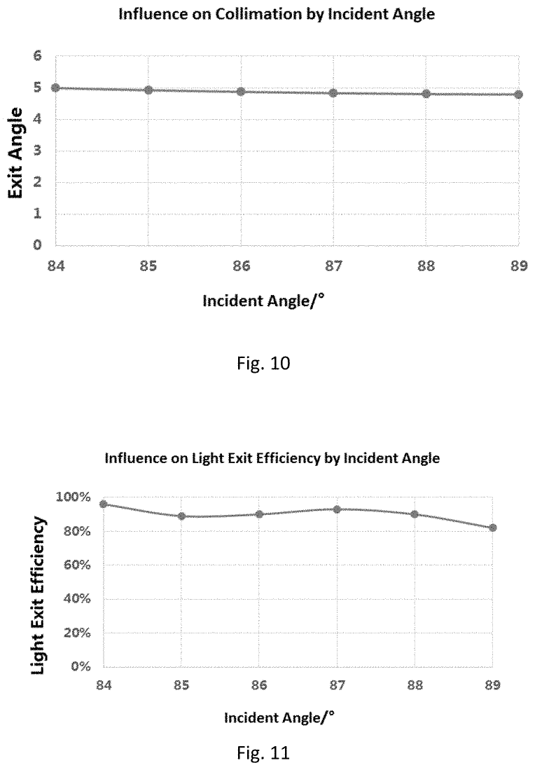

As shown in FIG. 10, when the incident angle varies and the other parameters are fixed, a result of variation of the exit angle along with the incident angle is as follows: the incident angle fluctuates from 84° to 89°, and the exit angle fluctuates from 4.99° to 4.79°. The incident angle has substantially no influence on the exit angle.

As shown in FIG. 11, when the incident angle varies and the other parameters are fixed, a result of variation of the light exit rate along with the incident angle is as follows: the incident angle fluctuates from 84° to 89°, and the light exit efficiency is still kept above 89%, which is high.

As seen from simulation results of FIGS. 10 and 11, incidence of light at a large angle has no significant influence on collimation and light exit efficiency of the multi-stage step grating. Thus, in the present application, the transmissive grating has a high collimation for collimating light beams incident at a large angle.

The following points should be noted.

(1) The drawings of the embodiments of the present disclosure refer only to the structures involved in the embodiments of the present disclosure, and other structures may refer to the general design.

(2) For the sake of clarity, in the drawings for describing embodiments of the present disclosure, the thickness of layers or regions is enlarged or reduced, that is, the drawings are not drawn to actual scales. It will be understood that when an element such as a layer, a film, a region or a substrate is referred to as being “on” or “below” another element, the element may be “directly” located “on” or “below” the other element, or there may be intermediate elements.

(3) The embodiments of the present disclosure and the features of the embodiments may be combined with each other to obtain a new embodiment without conflict.

The embodiments disclosed in the present disclosure are as described above, but are merely used to facilitate the understanding of the present disclosure, and are not intended to limit the present disclosure. Any modification and variation in the form and details of the implementation may be made by those skilled in the art without departing from the spirit and scope of the disclosure. The scope defined by the appended claims shall prevail in the patent protection scope of the present disclosure.

1. A light beam collimation structure, comprising:
a lens having a first primary axis and a first focus, for transmitting and collimating light from the first focus into parallel light in parallel with the first primary axis;
a grating structure disposed outside of a region formed by the first focus and a clear aperture of the lens and in a direction of the first primary axis, located between the lens and the first focus, the grating structure including a transmissive grating for transmitting and collimating light from the first focus into parallel light in parallel with the first primary axis.

2. The light beam collimation structure according to claim 1, wherein in a direction perpendicular to the first primary axis, the transmissive grating is located in a region outside of the clear aperture of the lens.

3. The light beam collimation structure according to claim 1, wherein the transmissive grating is a step grating.

4. The light beam collimation structure according to claim 3, wherein the transmissive grating has a step number of greater than 3.

5. The light beam collimation structure according to claim 4, wherein the transmissive grating has a period ranging from 0.5 to 5 μm and a refractive index ranging from 1.2 to 2.

6. The light beam collimation structure according to claim 1, wherein the grating structure further includes a reflective grating for reflecting light from the first focus, the reflective grating is disposed outside of a region formed by the first focus and both ends of the transmissive grating and located outside of a light exit region of transmitted light of the transmissive grating.

7. The light beam collimation structure according to claim 6, wherein the reflective grating includes a first reflective grating and a second reflective grating, the first reflective grating is located on one side of the first focus, and the second reflective grating is located on other side of the first focus.

8. A light beam collimation substrate including a plurality of the light beam collimation structures, and each of the plurality of light beam collimation structures comprising:
a lens having a first primary axis and a first focus, for transmitting and collimating light from the first focus into parallel light in parallel with the first primary axis;
a grating structure disposed outside of a region formed by the first focus and a clear aperture of the lens and in a direction of the first primary axis, located between the lens and the first focus, the grating structure including a transmissive grating for transmitting and collimating light from the first focus into parallel light in parallel with the first primary axis,
wherein a distance between lenses of the respective light beam collimation structures is greater than zero, and the first primary axes of the lenses of the respective light beam collimation structures are in parallel, and in a direction perpendicular to the first primary axis, the transmissive grating is located between two adjacent lenses.

9. The light beam collimation substrate according to claim 8, wherein a width of the transmissive grating is equal to a distance between the two adjacent lenses of the transmissive grating.

10. The light beam collimation substrate according to claim 19, wherein in a direction perpendicular to the first primary axis, the reflective grating is located between two adjacent transmissive gratings, the two adjacent transmissive gratings being two transmissive gratings closest to both sides of the lens of a light beam collimation structure where the reflective grating resides, or, the reflective grating is located between a boundary of the light beam collimation substrate and the transmissive grating which belongs to the same light beam collimation structure as the reflective grating.

11. The light beam collimation substrate according to claim 8, wherein the light beam collimation substrate further comprises a second lens having a second primary axis and a second focus, the second lens for transmitting and collimating light form the second focus into parallel light in parallel with the second primary axis, the second primary axis being parallel to the first primary axis, one side of the second lens being adjacent to one light beam collimation structure, other side of the second lens being close to a boundary of the light beam collimation substrate, a distance between the second lens and an adjacent lens being greater than zero.

12. The light beam collimation substrate according to claim 11, wherein the light beam collimation substrate further comprises a third reflective grating and a fourth reflective grating, which are disposed below the second lens and outside of a region formed by the second focus and a clear aperture of the second lens, located between the second lens and the second focus in a direction of the second primary axis, and located between a transmissive grating adjacent to the third reflective grating and the fourth reflective grating and a boundary of the light beam collimation substrate in a direction perpendicular to the second primary axis.

13. A backlight module, comprising: a light source substrate, and a light beam collimation substrate, which is disposed on a light exit side of the light source substrate, the light beam collimation substrate including a plurality of light beam collimation structures, and each of the light beam collimation structure comprising:
a lens having a first primary axis and a first focus, for transmitting and collimating light from the first focus into parallel light in parallel with the first primary axis;
a grating structure disposed outside of a region formed by the first focus and a clear aperture of the lens and in a direction of the first primary axis, located between the lens and the first focus, the grating structure including a transmissive grating for transmitting and collimating light from the first focus into parallel light in parallel with the first primary axis,
wherein a distance between lenses of the respective light beam collimation structures is greater than zero, and the first primary axes of the lenses of the respective light beam collimation structures are in parallel, and in a direction perpendicular to the first primary axis, the transmissive grating is located between two adjacent lenses,
wherein the light source substrate including a plurality of light sources in one-to-one correspondence with lenses on the light beam collimation substrate and disposed on focuses of corresponding lenses.

14. A display apparatus, comprising the backlight module according to claim 13.

15. The light beam collimation substrate according to claim 8, wherein in a direction perpendicular to the first primary axis, the transmissive grating is located in a region outside of the clear aperture of the lens.

16. The light beam collimation substrate according to claim 8, wherein the transmissive grating is a step grating.

17. The light beam collimation substrate according to claim 16, wherein the transmissive grating has a step number of greater than 3.

18. The light beam collimation substrate according to claim 17, wherein the transmissive grating has a period ranging from 0.5 to 5 μm and a refractive index ranging from 1.2 to 2.

19. The light beam collimation substrate according to claim 8, wherein the grating structure further includes a reflective grating for reflecting light from the first focus, the reflective grating is disposed outside of a region formed by the first focus and both ends of the transmissive grating and located outside of a light exit region of transmitted light of the transmissive grating.

20. The light beam collimation substrate according to claim 19, wherein the reflective grating includes a first reflective grating and a second reflective grating, the first reflective grating is located on one side of the first focus, and the second reflective grating is located on other side of the first focus.
